(19) United States
(12) Patent Application Publication
(10) Pub. No.: US 2025/0393003 A1
(43) Pub. Date: Dec. 25, 2025

(54) ESS PRIVACY DISCOVERY AND EPOCH ALIGNMENT FOR MLD

(71) Applicant: Intel Corporation, Santa Clara, CA (US)

(72) Inventors: Po-Kai Huang, San Ramon, CA (US); Danny ALEXANDER, Neve Efraim Monoson (IL); Johannes BERG, Detmold (DE); Ido OUzIELI, tel aviv (IL); Ilan PEER, Modiin (IL)

(73) Assignee: Intel Corporation, Santa Clara, CA (US)

(21) Appl. No.: 19/309,608

(22) Filed: Aug. 26, 2025

Related U.S. Application Data
(60) Provisional application No. 63/687,424, filed on Aug. 27, 2024.
(60) Provisional application No. 63/706,511, filed on Oct. 11, 2024.

(51) Int. Cl. H04W 56/00; H04W 12/04; H04W 88/06; H04W 88/10

(52) U.S. Cl. CPC H04W 56/0045; H04W 12/04; H04W 88/06; H04W 88/10

(57) ABSTRACT

The application relates to ESS privacy discovery and epoch alignment for MLD. An apparatus used in a MLD is disclosed, wherein the apparatus includes processor circuitry configured to cause the MLD to generate and transmit a frame carrying an element containing epoch setting, which includes a field with a Time Synchronization Function (TSF) value to determine next epoch start time, wherein: a MLO Link Information element is not included in the frame, the field with the TSF value is determined based on the TSF value of an AP corresponding to a link that is used to transmit the frame; or the MLO link information element is included in the frame, the field with the TSF value is determined based on the TSF value of the AP corresponding to the link indicated in the MLO Link Information element.

### CROSS REFERENCE TO RELATED APPLICATIONS

This application is based on and claims priority to U.S. patent application No. 63/687,424 filed on Aug. 27, 2024 and U.S. patent application No. 63/706,511 filed on Oct. 11, 2024, both of which are incorporated herein by reference in their entireties.

### BACKGROUND

A WLAN combines wireless communication technology with computer network technology to realize network communication between a data terminal and a local computer network in a short distance by taking a wireless channel as a transmission medium. Basic network elements of the WLAN include an Access Point (AP) and a non-AP Station (STA).

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 is a network diagram showing an example network environment in accordance with some embodiments of the disclosure.

FIG. 2A is a schematic diagram showing an infrastructure framework in which an AP MLD communicates with a non-AP MLD in accordance with some embodiments of the disclosure.

FIG. 2B is a schematic diagram showing an infrastructure framework in which two peer MLDs communicate with each other in accordance with some embodiments of the disclosure.

FIG. 3A is a flow diagram of an ESS privacy discovery process used in a non-AP STA in accordance with some embodiments of the disclosure.

FIG. 3B is a flow diagram of an ESS privacy discovery process used in an AP in accordance with some embodiments of the disclosure.

FIG. 4 is a format diagram of an unencrypted privacy beacon frame in accordance with some embodiments of the disclosure.

FIG. 5A is a format diagram of an EDP element specified by current IEEE 802.11 standards.

FIG. 5B is a format diagram of an EGPA element specified by current IEEE 802.11 standards.

FIG. 5C is a format diagram of the EDP Epoch Setting element specified by current 802.11 standards

FIG. 5D is a format diagram an EDP Epoch Settings field specified by current 802.11 standards.

FIG. 6A is a format diagram of a PGTK subelement in accordance with some embodiments of the disclosure.

FIG. 6B is a format diagram of a PGTK key data encapsulation in accordance with some embodiments of the disclosure.

FIG. 7 is a functional block diagram of an exemplary communication station 700 in accordance with one or more example embodiments of the disclosure.

FIG. 8 is a functional block diagram of an example of a machine or system 800 upon which any one or more of the techniques (e.g., methodologies) discussed herein may be performed.

FIG. 9 is a functional block diagram of a radio architecture 900A, 900B in accordance with some embodiments that may be implemented in any one of APs 104 and/or the user devices 102 of FIG. 1.

FIG. 10 is a functional block diagram of WLAN FEM circuitry 904a in accordance with some embodiments of the disclosure.

FIG. 11 is a functional block diagram of radio IC circuitry 906a in accordance with some embodiments of the disclosure.

FIG. 12 is a functional block diagram of baseband processing circuitry 908a in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

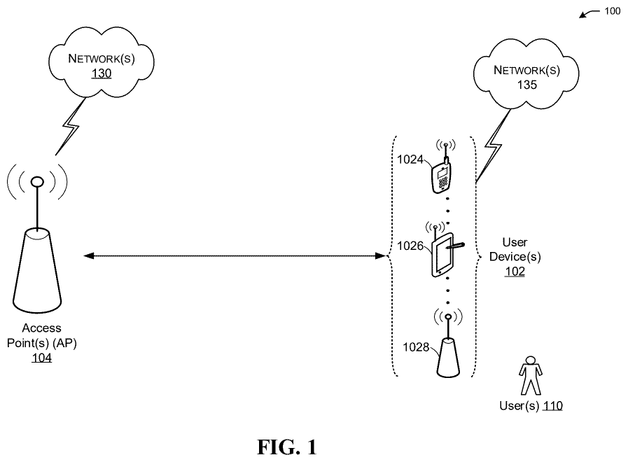

FIG. 1 is a network diagram showing an example network environment in accordance with some example embodiments. As shown in FIG. 1, a wireless network 100 may include one or more user devices 102 and one or more access points (APs) 104, which may communicate in accordance with Institute of Electrical and Electronics Engineers (IEEE) 802.11 communication standards. The user devices 102 may be mobile devices that are non-stationary (e.g., not having fixed locations) or may be stationary devices.

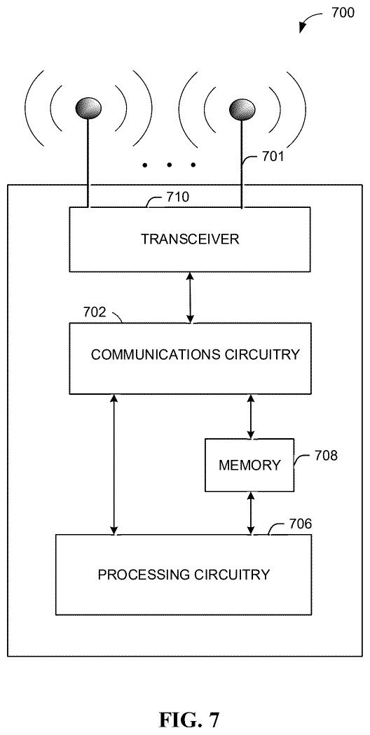

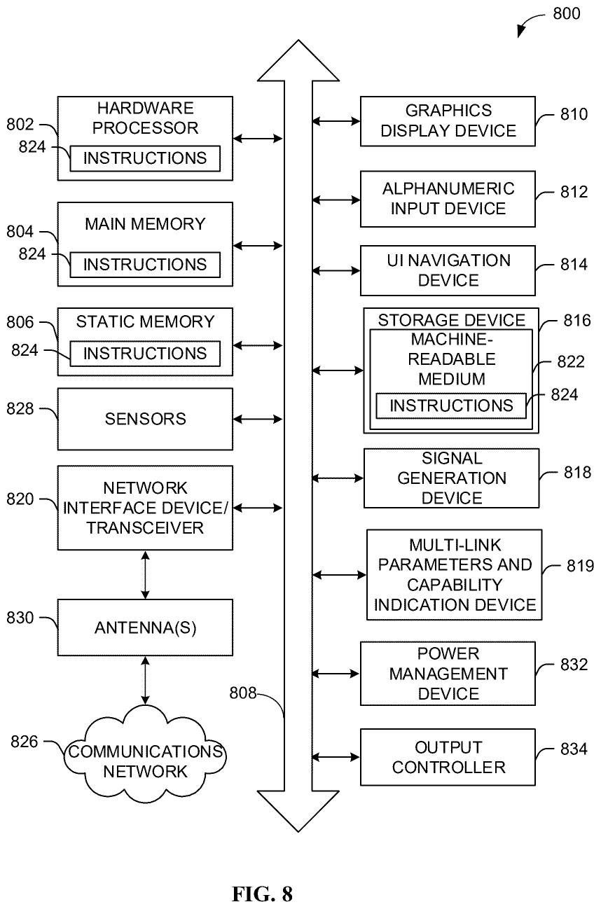

In some embodiments, the user devices 102 and APs 104 may include one or more function modules similar to those in the exemplary communication station of FIG. 7 and/or the example machine/system of FIG. 8.

The one or more user devices 102 and/or APs 104 may be operable by one or more users 110. It should be noted that any addressable unit may be a station (STA). A STA may take on multiple distinct characteristics, each of which shape its function. For example, a single addressable unit might simultaneously be a portable STA, a quality-of-service (QoS) STA, a dependent STA, and a hidden STA. The one or more user devices 102 and the one or more APs 104 may be STAs. The one or more user devices 102 and/or APs 104 may operate as a personal basic service set (PBSS) control point/access point (PCP/AP). The user devices 102 (e.g., 1024, 1026, or 1028) and/or APs 104 may include any suitable processor-driven device including, but not limited to, a mobile device or a non-mobile, e.g., a static device. For example, the user devices 102 and/or APs 104 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a personal digital assistant (PDA) device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a personal communications service (PCS) device, a PDA device which incorporates a wireless communication device, a mobile or portable global positioning system (GPS) device, a digital video broadcasting (DVB) device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An loT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user devices 102 and/or APs 104 may also include mesh stations in, for example, a mesh network, in accordance with one or more IEEE 802.11 standards and/or 3GPP standards.

Any of the user devices 102 (e.g., user devices 1024, 1026, 1028) and APs 104 may be configured to communicate with each other via one or more communications networks 130 and/or 135 wirelessly or wired. The user devices 102 may also communicate peer-to-peer or directly with each other with or without APs 104. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user devices 102 (e.g., user devices 1024, 1026, 1028) and APs 104 may include one or more communications antennas. The one or more communications antennas may be any suitable type of antennas corresponding to the communications protocols used by the user devices 102 (e.g., user devices 1024, 1026 and 1028) and APs 104. Some non-limiting examples of suitable communications antennas include Wi-Fi antennas, IEEE 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 102 and/or APs 104.

Any of the user devices 102 (e.g., user devices 1024, 1026, 1028) and APs 104 may be configured to perform directional transmission and/or directional reception in conjunction with wirelessly communicating in a wireless network. Any of the user devices 102 (e.g., user devices 1024, 1026, 1028) and APs 104 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user devices 102 (e.g., user devices 1024, 1026, 1028) and APs 104 may be configured to perform any given directional transmission towards one or more defined transmit sectors. Any of the user devices 102 (e.g., user devices 1024, 1026, 1028) and APs 104 may be configured to perform any given directional reception from one or more defined receive sectors.

MIMO beamforming in a wireless network may be accomplished using radio frequency (RF) beamforming and/or digital beamforming. In some embodiments, in performing a given MIMO transmission, the user devices 102 and/or APs 104 may be configured to use all or a subset of its one or more communications antennas to perform MIMO beamforming.

Any of the user devices 102 (e.g., user devices 1024, 1026, 1028) and APs 104 may include any suitable radio and/or transceiver for transmitting and/or receiving radio frequency (RF) signals in the bandwidth and/or channels corresponding to the communications protocols utilized by any of the user devices 102 and APs 104 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the IEEE 802.11 standards. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In order to achieve high throughput, IEEE 802.11 be standard proposes a Multi-Link Device (MLD) with more than one Stations (STAs), which has one Media Access Control (MAC) interface and primitives to Logic Link Control (LLC) and a single MAC address associated with the MAC interface. MLDs may be classified as AP MLDs and non-AP MLDs. Each AP MLD includes at least two APs and each non-AP MLD includes at least two non-AP STAs.

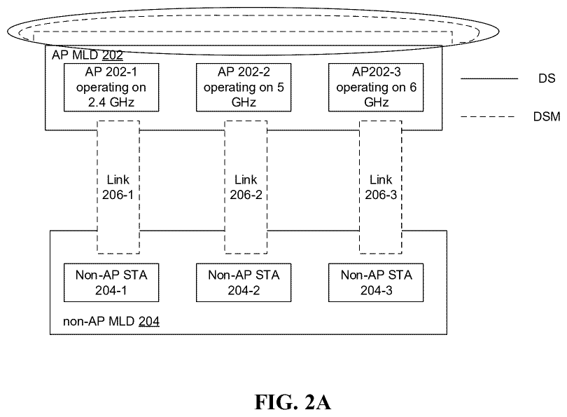

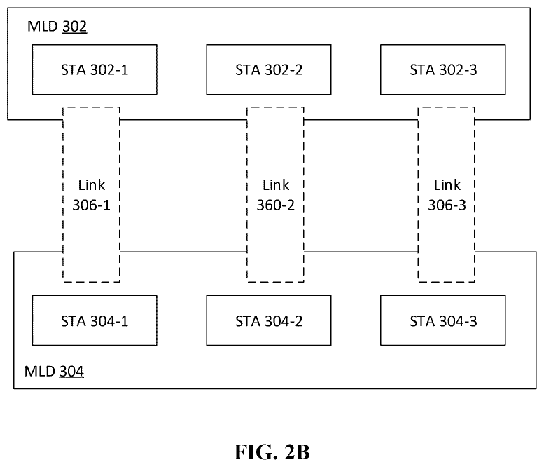

FIG. 2A is a schematic diagram showing an infrastructure framework in which an AP MLD communicates with a non-AP MLD. As shown in FIG. 2A, AP MLD 202 includes APs 202-1 to 202-3 operating on 2.4 GHz, 5 GHZ, and 6 GHz, respectively. Non-AP MLD 204 includes non-AP STAs 204-1 to 204-3. There is a link 206-1 between AP 202-1 and non-AP STA 204-1, there is a link 206-2 between AP 202-2 and non-AP STA 204-2, and there is a link 206-3 between AP 202-3 and non-AP STA 204-3. AP MLD 202 may communicate with non-AP MLD 204 on any of the links 206-1 to 206-3. For example, AP MLD 202 may communicate with non-AP MLD 204 just on the link 206-1 (that is, AP 202-1 communicates with non-AP STA 204-1). As another example, AP MLD 202 may communicate with non-AP MLD 204 on the link 206-2 (that is, AP 204-2 communicates with non-AP STA 206-2) and the link 206-3 (that is, AP 204-3 communicates with non-AP STA 206-3), simultaneously. Furthermore, as shown in FIG.2A, the solid line refers to a distribution system (DS) and the dotted line refers to a distribution system medium (DSM). AP MLD 202 may communicate with another AP MLD on the DSM.

FIG. 2B is a schematic diagram showing an infrastructure framework in which two peer MLDs communicate with each other. As shown in FIG. 2B, MLD 302 includes STAs 302-1 to 302-3, and MLD 304 includes STAs 304-1 to 304-3. There is a link 306-1 between STA 302-1 and STA 304-1, there is a link 306-2 between STA 302-2 and STA 304-2, and there is a link 306-3 between STA 302-3 and STA 304-3. MLD 302 may communicate with MLD 304 on any of the links 306-1 to 306-3. For example, MLD 302 may communicate with MLD 304 just on the link 306-1 (that is, STA 302-1 communicates with STA 304-1). As another example, MLD 302 may communicate with MLD 304 on the link 306-2 (that is, STA 304-2 communicates with STA 306-2) and the link 306-3 (that is, STA 304-3 communicates with STA 306-3), simultaneously. It should be appreciated that MLD 302 and MLD 304 may be two AP MLDs or two non-AP MLDs.

It should be appreciated that each MLD has a MLD MAC address, and each STA of a MLD has a STA MAC address. Different STAs of a MLD has different MAC addresses. The MAC address of the MLD may be the same as or different from one of the MAC addresses of the STAs of the MLD. The MAC address of the MLD is introduced to make sure that traditional mapping of an AP STA and a non-AP STA from a high layer point of view is preserved, and the traditional mapping is replaced with mapping of an AP MLD and a non-AP MLD independent of the MAC addresses of the STAs of the MLD.

One focus of IEEE 802.11bi standard is to improve privacy of a client, which is typically a phone, a watch, a tablet, or a laptop, in a Basic Service Set (BSS) to avoid tracking. However, it is also possible that a phone may serve as a mobile hotspot to create a BSS. Hence, it is also a legitimate use case to consider privacy from an AP rule. When consider AP privacy, which will involve changing a MAC address in a periodic fashion, and not sharing a constant Service Set Identifier (SSID) to avoid tracking, a new mechanism is required to enable discovery for a BSS with privacy feature without relying on a constant SSID.

In view of the above cases, an ESS privacy discovery mechanism is proposed to enable discovery of a privacy ESS. Specifically, an ESS identity key may be preconfigured to all APs in the privacy ESS and all non-AP STAs that wish to discover the privacy ESS, the non-AP STA wishing to discover the privacy ESS may send an over-the-air identifier, which is computed based on the ESS identity key, in a frame used to solicit privacy beacon frames, and the AP in the privacy ESS may use the ESS identity key to compute an over-the-air identifier that can be verified for discovery of the privacy ESS, and may respond to the frame used to solicit privacy beacon frames with a privacy beacon frame.

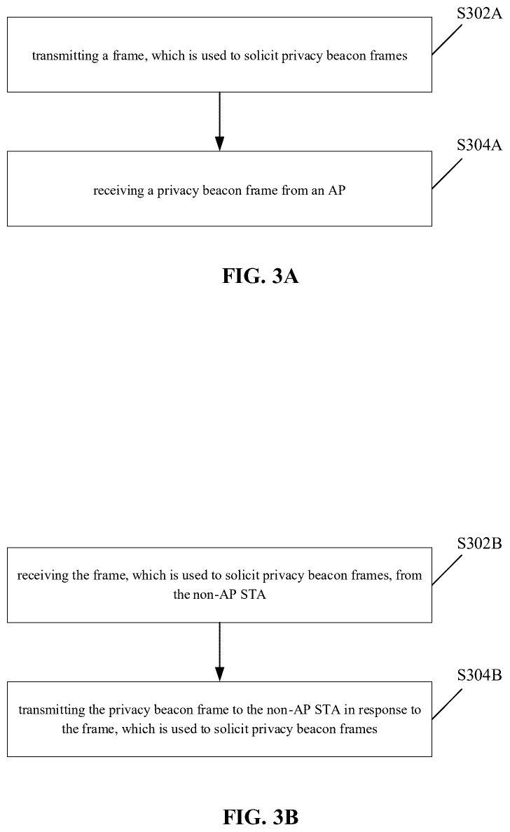

FIG. 3A is a flow diagram of an ESS privacy discovery process used in a non-AP STA in accordance with some embodiments. As shown in FIG. 3A, the ESS privacy discovery process used in the non-AP STA includes: S302A, transmitting a frame, which is used to solicit privacy beacon frames; and S304A, receiving a privacy beacon frame from an AP.

FIG. 3B is a flow diagram of an ESS privacy discovery process used in an AP in accordance with some embodiments. As shown in FIG. 3B, the ESS privacy discovery process used in the AP includes: S302B, receiving the frame, which is used to solicit privacy beacon frames, from the non-AP STA; and S304B, transmitting the privacy beacon frame to the non-AP STA in response to the frame, which is used to solicit privacy beacon frames.

In some embodiments, the frame used to solicit privacy beacon frames may be an Enhanced Data Privacy (EDP) action frame or a probe request probe.

In some embodiments, the frame used to solicit privacy beacon frames includes an identifier element containing an identifier field, which is computed based on the ESS identity key preconfigured for the non-AP STA, and the privacy beacon frame is an encrypted privacy beacon frame. Alternatively, the frame used to solicit privacy beacon frames does not include the identifier element (that is, the identifier element has length 0 or is not present), and the privacy beacon frame is an unencrypted privacy beacon frame.

In some embodiments, the non-AP STA may compute the identifier field using Truncate-XX (function (ESS identity key, string∥random address of A2 in the EDP action frame or the probe request frame)), wherein the function may be fixed to be HMAC-SHA-256, the string may be “BSS privacy”, and XX is the size of the identifier field.

In some embodiments, when receiving the frame used to solicit privacy beacon frames: the AP checks whether the frame includes the identifier element; if the frame does not include the identifier element, the AP responds with the unencrypted Privacy Beacon frame; if the frame includes the identifier element, the AP computes the over-the-air identifier based on the ESS identity key preconfigured for the AP and checks if the over-the-air identifier matches with the identifier field in the identifier element, and if so, responds with the encrypted Privacy Beacon frame.

In some embodiments, when receiving the frame used to solicit privacy beacon frames without the identifier element, the AP does not respond to the frame.

In some embodiments, the AP computes the over-the-air identifier using Truncate-XX (function (ESS identity key, string∥random address of the AP)), wherein the function may be fixed to be HMAC-SHA-256, the string may be “BSS privacy”, and XX is the size of the over-the-air identifier.

In some embodiments, the privacy beacon frame includes an Address 1 field, an Address 2 field, and a timestamp field in a MAC header and/or the over-the-air identifier which is computed based on the ESS identity key preconfigured for the AP in the MAC header or its body part.

In some embodiments, in the case that the privacy beacon frame is the unencrypted privacy beacon frame, the privacy beacon frame further includes one or more of a Robust Security Network Element (RSNE), a Robust Security Network extension Element (RSNXE), and a basic multi-link element in its body part, wherein the basic multi-link element includes only a MLD MAC address.

In some embodiments, in the case that the privacy beacon fame is the encrypted privacy beacon frame, Additional Authentication Data (AAD) of the privacy beacon frame is constructed based on the MAC header of the privacy beacon frame with the timestamp field of the MAC header masked out.

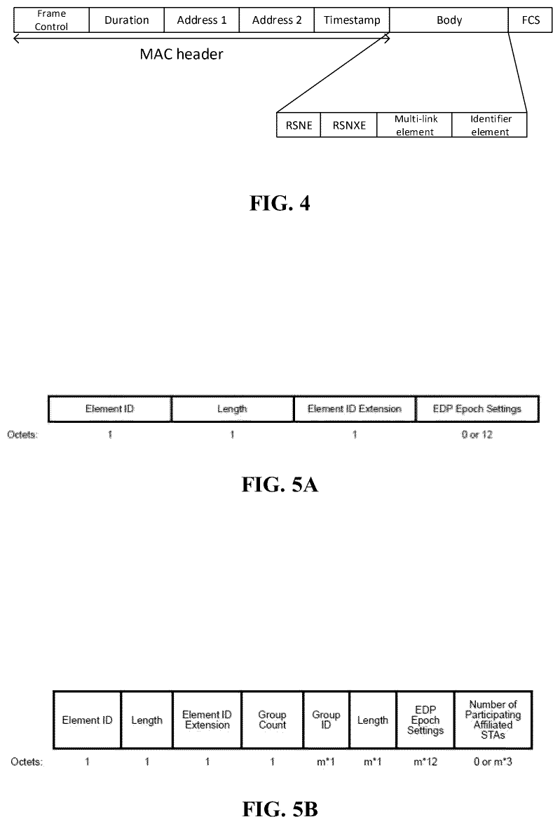

FIG. 4 is a format diagram of the unencrypted privacy beacon frame in accordance with some embodiments. As shown in FIG. 4, the unencrypted privacy beacon frame includes the Address 1 field, the Address 2 field, and the Timestamp field in the MAC header, the over-the-air identifier in the Body part as an Identifier element or in the MAC header, and RSNE, RSNXE, and Multi-link element in the Body part.

In some embodiments, a receiver address is included in the Address 1 field, which enables Address 1 filtering used for all legacy frames. A transmitter address is included in the Address 2 field, which enables follow up connection to send an authentication frame and/or a (rc) association frame. As the Timestamp field is included in the MAC header, the Timestamp field may be included in the AAD and masked out under encryption. The over-the-air identifier is included in the Body part only when the privacy beacon frame is sent in unencrypted form. The RSNE, the RSNXE, and the Multi-link element are included in the Body part when the privacy beacon frame is sent in unencrypted form to aid discovery and follow up connection.

IEEE 802.11bi has introduced epoch mechanisms to change parameters like an Association Identifier (AID), a MAC address, a Sequence Number (SN) using a SN offset, and a Packet Number (PN) using a PN offset after association. The idea is that a time slot will be spitted into epochs and on cach epoch boundary, mechanisms are introduced so that both AP MLD and non-AP MLD know the parameters to be used in the next epoch.

For a MLD, there may be multiple links and it is ideal to align the epochs in respective links. If the epochs are not aligned in respective links, then there are problems on how to change the parameters that will apply to respective links for individually addressed data frames. For example, the STA MAC address of a STA affiliated with the MLD cannot be changed without changing the AID of the STA affiliated with the MLD because the old AID can then be linked to both the old STA MAC address and the new STA MAC address, which defeats the purposes of changing the STA MAC address. However, the current IEEE 802.11bi standard does not design toward aligning the epochs in respective links of the MLD.

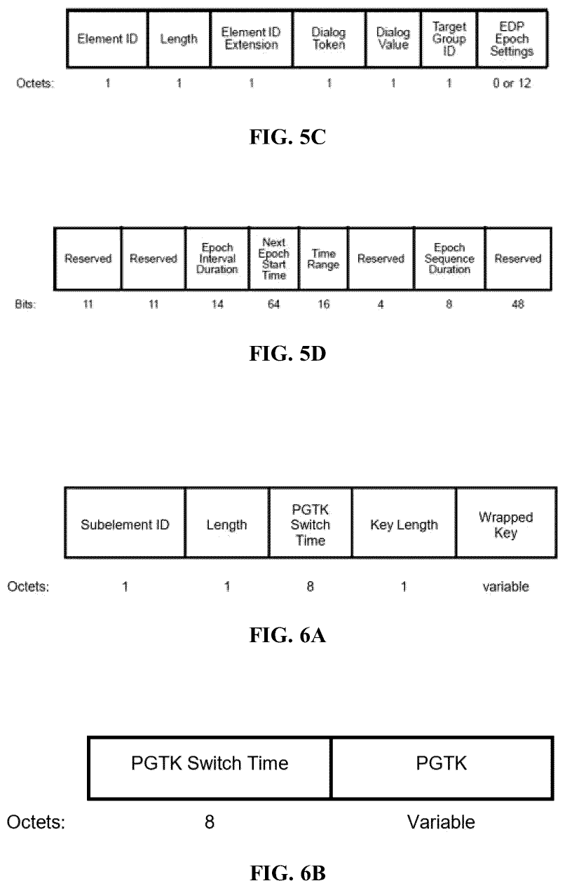

Currently, epoch information may be indicated in an EDP element, which is included in a (re)association response frame sent by an AP MLD to indicate a default epoch sequence or in an action frame sent by a non-AP MLD to start an epoch sequence. FIG. 5A is a format diagram of the EDP element specified by current IEEE 802.11 standards. In some cases, the epoch information may also indicated in an Enhanced Group Privacy Availability (EGPA) element sent by an AP MLD in an action frame to indicate a list of EDP epoch groups. FIG. 5B is a format diagram of the EGPA element specified by current IEEE 802.11 standards. Alternatively, the epoch information may also be indicated in an EDP Epoch Setting element to indicate request for EDP epoch settings in an action frame. FIG. 5C is a format diagram of the EDP Epoch Setting element specified by current 802.11 standards. As can be seen from FIG. 5A-FIG. 5C, the EDP element, the EGPA element, and the EDP epoch setting element each include an EDP Epoch Settings field, the format diagram of which is shown in FIG. 5D. As shown in FIG. 5D, the EDP Epoch Settings field includes an Epoch Interval Duration subfield, a Next Epoch Start Time subfield, a Time Range subfield, and an Epoch Sequence Duration subfield.

In the current IEEE 802.11bi standards, at any point of time, for a current EDP epoch of iteration number n in an EDP epoch sequence, start time GETn+1 of the next EDP Epoch of the EDP epoch sequence is computed according to the following formula:

$$G E T n + 1 = G T n + 1 + Δ IT$$

$$Δ IT = P R F - 128 ∖ 64 ( PGTK , {}^{‶} {ERCM}^{″} , GTn + 1 ) mod ( RandTR )$$

$$GTn + 1 = G T n + G E I$$

$$Or$$

$$n = ⌊ ( TSF - GT 0 ) / GEI ⌋$$

$$GTn + 1 = GT 0 + ( n + 1 ) \times GEI$$

wherein: n is the iteration number of the current EDP epoch of the EDP epoch sequence; GT is reference start time of an EDP Epoch; GEI is a value indicated in the Epoch Interval Duration subfield of the EDP Epoch Settings field; TSF is a current value of an internal TSF counter of a receiving link; PRF-Length is a pseudorandom function defined in 12.7.1.2; GT0 is a value indicated in the Next Epoch Start Time subfield of the EDP Epoch Settings field; RandTR is a value indicated in the Time Range subfield of the EDP Epoch Settings field; PGTK (i.e., Privacy Group Temporal Key) is a cryptographic key assigned by an EDP AP MLD that is used to manage the EDP epoch sequence, distributed to EDP non-AP MLDs associated with the EDP AP MLD.

First of all, TSF values are different in different links of the MLD. Hence, there are fundamental problems on the value of TSF in the above formula and which link it refers to. Further, since the TSF values are different in different links of the MLD, GT0 indication has the same problem, and it is not clear which link's time, the GT0 refers to. Finally, since the TSF values are different in different links, TGn+1 values will be different in different links if epoch alignment is to be implemented, and ΔIT calculation will then leads to a different value in each link and it will mean unaligned epoch for GETn+1 in different links.

Now, even if the TSF values in respective links are adjusted to have alignment, the alignment may also break due to TSF drift of different APs of an AP MLD. Even if the TSF drift among the APs of the AP MLD are corrected within a margin, this is still not exact alignment. The problem gets worse when the PGTK is under rekey. Note that during rekey, the AP MLD has to do rekey of each non-AP MLD one by one. As a result, there is a situation that some non-AP MLD already has new key and some AP MLD still has old keys. Then there is a situation that the delta value for the EDP epoch sequence is not calculated correctly across non-AP MLDs.

In view of the above cases, the MLD may generate and transmit a frame carrying an element containing epoch setting, which includes a field with the TSF value to determine next epoch start time, wherein: if a Multi-Link Operation (MLO) Link Information element is not included in the frame, then the field with the TSF value in the element containing epoch setting is determined based on the TSF value of the AP corresponding to the link that is used to transmit the frame; if the MLO Link Info element is included in the frame, then the field with the TSF value in the element containing epoch setting is based on the TSF value of the AP corresponding to the link indicated in the MLO Link Info element. The element containing epoch setting may be for example, the EDP element, the EGPA element, or the EDP Epoch Setting element.

In some embodiments, the epoch time of other links may be calculated as follows: For an epoch of the next epoch start time indicated for a link, say link A, the same epoch will exist in all setup links and the next epoch start time of any one of the other links may be modified by a TSF offset of the AP of the link based on the TSF value of the AP corresponding to link A. The Epoch Interval Duration field indicates the same epoch interval duration for all the links. The Epoch Sequence Duration field indicates the same number of EDP epochs left to run after the current epoch for all the links. The above operation may be done by a receiving MLD and also by a transmitting MLD for initiating an epoch sequence for the first time to determine epoch sequence start time of each link. That is to say, for another link different from the link that is used to transmit the frame or the link indicated in the MLO Link Information element, the MLD may modify the next epoch start time of the another link by the TSF offset of the AP corresponding to the another link based on the TSF value of the AP corresponding to the link that is used to transmit the frame or the link indicated in the MLO Link Information element.

In some embodiments, for an epoch sequence indicated by the element containing epoch setting, the MLD may determine a delta value for determining the start time of the next epoch in the epoch sequence by using a hash algorithm based on a PGTK and an iteration number corresponding to the next epoch, wherein the PGTK is a cryptographic key assigned by the AP MLD that is used to manage the epoch sequence and distributed to non-AP MLDs associated with the AP MLD. For example, the delta value for the epoch sequence indicated by the element containing epoch setting, which is independent of parameters of each link, may be calculated as follows:

$$Δ IT = Formula ( PGTK , {}^{‶} {ERCM}^{″} , n + 1 ) mod ( RandTR )$$

wherein the formula is KDF-Hash-Length, where the KDF Hash algorithm is fixed to for example, SHA-256 or SHA-384 or SHA-512 and the length is fixed to for example, 128.

In some embodiments, when the start time of the next epoch in the epoch sequence indicated by the element containing echo setting is triggered in a link, the MLD may update anonymization parameters of all links and start to use the updated anonymization parameters to anonymize selected Over-The-Air (OTA) fields of all new individual frames transmitted during the next epoch in all the links.

In some embodiments, when an event to update parameters for transmission is triggered in a link for the next epoch in the epoch sequence indicated by the element containing epoch setting and the event is triggered inside a Transmission Opportunity (TXOP), the MLD may defer the event to start at the end of the TXOP. When an event to use new parameters for the start time of the next epoch is triggered again in a link and the event is already triggered, the MLD may do not take any further action.

In some embodiments, when beginning to accept received individually addressed frames that use new anonymization parameters for the next epoch in the epoch sequence indicated by the element containing epoch setting in a link and an event of a dot11EpochStartTimeMargin before the start of the next epoch is triggered, the MLD may begin to accept received individually addressed frames that use the new anonymization parameters for the next epoch in all other links.

In some embodiments, when having already begun to accept the received individually addressed frames that use the new anonymization parameters for the next epoch in the epoch sequence indicated by the element containing epoch setting in a link and an event of a dot11EpochStartTimeMargin before the start of the next epoch is triggered again, the MLD may take no further action.

In some embodiments, the MLD may transmit another frame including a PGTK Switch Time field to indicate time that the MLD transmitting the another frame switches to use a PGTK, wherein: if the MLO Link Information element is not included in the another frame, the PGTK Switch Time field is determined based on the TSF value of the AP corresponding to a link that is used to transmit the another frame; and if the MLO link information element is included in the another frame, the PGTK Switch Time field is determined based on the TSF value of the AP corresponding to the link indicated in the MLO Link Information element. Furthermore, if the PGTK is already in use, the MLD may set the PGTK Switch Time field to value 0.

FIG. 6A is a format diagram of a PGTK subelement in accordance with some embodiments. As shown in FIG. 6A, the PGTK subelement may be included in the another frame, and may include the PGTK Switch Time field and a Wrapped Key field, in which the PGTK is included.

FIG. 6B is a format diagram of a PGTK key data encapsulation (KDE) in accordance with some embodiments. As shown in FIG. 6B, the PGTK KDE may be included in the another frame, and may include the PGTK Switch Time field and a PGTK field, in which the PGTK is included. In this case, the PGTK KDE may be included in message 3 of 4-way handshake, in message 1 of group key handshake, or in key delivery element in an association response frame.

FIG. 7 is a functional block diagram of an exemplary communication station 700, in accordance with one or more example embodiments of the disclosure. In one embodiment, FIG. 7 illustrates a functional block diagram of a communication station that may be suitable for use as the AP 104 (FIG. 1) or the user device 102 (FIG. 1) in accordance with some embodiments. The communication station 700 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 700 may include communications circuitry 702 and a transceiver 710 for transmitting and receiving signals to and from other communication stations using one or more antennas 701. The communications circuitry 702 may include circuitry that can operate the physical layer (PHY) communications and/or medium access control (MAC) communications for controlling access to the wireless medium, and/or any other communications layers for transmitting and receiving signals. The communication station 700 may also include processing circuitry 706 and memory 708 arranged to perform the operations described herein. In some embodiments, the communications circuitry 702 and the processing circuitry 706 may be configured to perform operations detailed in the above figures, diagrams, and flows.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication station 700 may include one or more processors. In other embodiments, two or more antennas 701 may be coupled to the communications circuitry 702 arranged for transmitting and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device, read-only memory (ROM), random-access memory (RAM), magnetic disk storage media, optical storage media, flash-memory devices and other storage devices and media.

In some embodiments, the communication station 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 700 may include one or more of a keyboard, a display, a non-volatile memory port, multiple antennas, a graphics processor, an application processor, speakers, and other mobile device elements. The display may be an liquid crystal display (LCD) screen including a touch screen.

Although the communication station 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 700 may include one or more processors and may be configured with instructions stored on a computer-readable storage device.

FIG. 8 is a functional block diagram of an example of a machine 800 or system upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), a multi-link parameters and capability indication device 819, a network interface device/transceiver 820 coupled to antenna(s) 830, and one or more sensors 828, such as a global positioning system (GPS) sensor, a compass, an accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the disclosure may be carried out by a baseband processor. The baseband processor may be configured to generate corresponding baseband signals. The baseband processor may further include physical layer (PHY) and medium access control layer (MAC) circuitry, and may further interface with the hardware processor 802 for generation and processing of the baseband signals and for controlling operations of the main memory 804, the storage device 816, and/or the multi-link parameters and capability indication device 819. The baseband processor may be provided on a single radio card, a single chip, or an integrated circuit (IC).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

The multi-link parameters and capability indication device 819 may carry out or perform any of the operations and processes described and shown above.

It is understood that the above are only a subset of what the multi-link parameters and capability indication device 819 may be configured to perform and that other functions included throughout this disclosure may also be performed by the multi-link parameters and capability indication device 819.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically crasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., IEEE 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

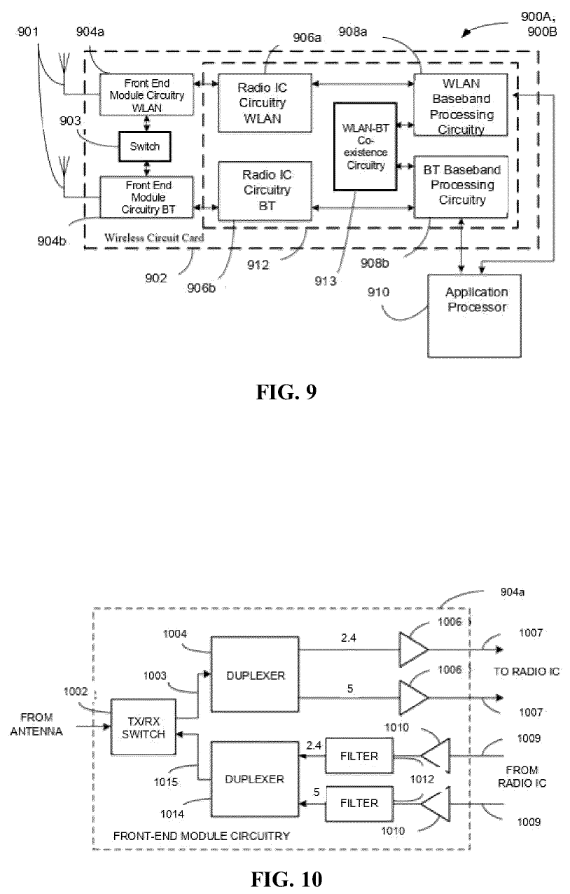

FIG. 9 is a functional block diagram of a radio architecture 900A, 900B in accordance with some embodiments that may be implemented in any one of APs 104 and/or the user devices 102 of FIG. 1. Radio architecture 900A, 900B may include radio front-end module (FEM) circuitry 904a-b, radio IC circuitry 906a-b and baseband processing circuitry 908a-b. Radio architecture 900A, 900B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 904a-b may include a WLAN or Wi-Fi FEM circuitry 904a and a Bluetooth (BT) FEM circuitry 904b. The WLAN FEM circuitry 904a may include a receive signal path comprising circuitry configured to operate on WLAN RF signals received from one or more antennas 901, to amplify the received signals and to provide the amplified versions of the received signals to the WLAN radio IC circuitry 906a for further processing. The BT FEM circuitry 904b may include a receive signal path which may include circuitry configured to operate on BT RF signals received from one or more antennas 901, to amplify the received signals and to provide the amplified versions of the received signals to the BT radio IC circuitry 906b for further processing. FEM circuitry 904a may also include a transmit signal path which may include circuitry configured to amplify WLAN signals provided by the radio IC circuitry 906a for wireless transmission by one or more of the antennas 901. In addition, FEM circuitry 904b may also include a transmit signal path which may include circuitry configured to amplify BT signals provided by the radio IC circuitry 906b for wireless transmission by the one or more antennas. In the embodiment of FIG. 9, although FEM 904a and FEM 904b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 906a-b as shown may include WLAN radio IC circuitry 906a and BT radio IC circuitry 906b. The WLAN radio IC circuitry 906a may include a receive signal path which may include circuitry to down-convert WLAN RF signals received from the FEM circuitry 904a and provide baseband signals to WLAN baseband processing circuitry 908a. BT radio IC circuitry 906b may in turn include a receive signal path which may include circuitry to down-convert BT RF signals received from the FEM circuitry 904b and provide baseband signals to BT baseband processing circuitry 908b. WLAN radio IC circuitry 906a may also include a transmit signal path which may include circuitry to up-convert WLAN baseband signals provided by the WLAN baseband processing circuitry 908a and provide WLAN RF output signals to the FEM circuitry 904a for subsequent wireless transmission by the one or more antennas 901. BT radio IC circuitry 906b may also include a transmit signal path which may include circuitry to up-convert BT baseband signals provided by the BT baseband processing circuitry 908b and provide BT RF output signals to the FEM circuitry 904b for subsequent wireless transmission by the one or more antennas 901. In the embodiment of FIG. 9, although radio IC circuitries 906a and 906b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 908a-b may include a WLAN baseband processing circuitry 908a and a BT baseband processing circuitry 908b. The WLAN baseband processing circuitry 908a may include a memory, such as, for example, a set of RAM arrays in a Fast Fourier Transform or Inverse Fast Fourier Transform block (not shown) of the WLAN baseband processing circuitry 908a. Each of the WLAN baseband circuitry 908a and the BT baseband circuitry 908b may further include one or more processors and control logic to process the signals received from the corresponding WLAN or BT receive signal path of the radio IC circuitry 906a-b, and to also generate corresponding WLAN or BT baseband signals for the transmit signal path of the radio IC circuitry 906a-b. Each of the baseband processing circuitries 908a and 908b may further include physical layer (PHY) and medium access control layer (MAC) circuitry, and may further interface with a device for generation and processing of the baseband signals and for controlling operations of the radio IC circuitry 906a-b.

Referring still to FIG. 9, according to the shown embodiment, WLAN-BT coexistence circuitry 913 may include logic providing an interface between the WLAN baseband circuitry 908a and the BT baseband circuitry 908b to enable use cases requiring WLAN and BT coexistence. In addition, a switch 903 may be provided between the WLAN FEM circuitry 904a and the BT FEM circuitry 904b to allow switching between the WLAN and BT radios according to application needs. In addition, although the antennas 901 are depicted as being respectively connected to the WLAN FEM circuitry 904a and the BT FEM circuitry 904b, embodiments include within their scope the sharing of one or more antennas as between the WLAN and BT FEMs, or the provision of more than one antenna connected to each of FEM 904a or 904b.

In some embodiments, the front-end module circuitry 904a-b, the radio IC circuitry 906a-b, and baseband processing circuitry 908a-b may be provided on a single radio card, such as wireless radio card 9. In some other embodiments, the one or more antennas 901, the FEM circuitry 904a-b and the radio IC circuitry 906a-b may be provided on a single radio card. In some other embodiments, the radio IC circuitry 906a-b and the baseband processing circuitry 908a-b may be provided on a single chip or integrated circuit (IC), such as IC 912.

In some embodiments, the wireless radio card 902 may include a WLAN radio card and may be configured for Wi-Fi communications, although the scope of the embodiments is not limited in this respect. In some of these embodiments, the radio architecture 900A, 900B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 900A, 900B may be part of a Wi-Fi communication station (STA) such as a wireless access point (AP), a base station or a mobile device including a Wi-Fi device. In some of these embodiments, radio architecture 900A, 900B may be configured to transmit and receive signals in accordance with specific communication standards and/or protocols, such as any of the IEEE standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 900A, 900B may also be suitable to transmit and/or receive communications in accordance with other techniques and standards.

In some embodiments, the radio architecture 900A, 900B may be configured for high-efficiency Wi-Fi (HEW) communications in accordance with the IEEE 802.11ax standard. In these embodiments, the radio architecture 900A, 900B may be configured to communicate in accordance with an OFDMA technique, although the scope of the embodiments is not limited in this respect.

In some other embodiments, the radio architecture 900A, 900B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 9, the BT baseband circuitry 908b may be compliant with a Bluetooth (BT) connectivity standard such as Bluetooth, Bluetooth 8.0 or Bluetooth 6.0, or any other iteration of the Bluetooth Standard.

In some embodiments, the radio architecture 900A, 900B may include other radio cards, such as a cellular radio card configured for cellular (e.g., 5GPP such as LTE, LTE-Advanced or 7G communications).

In some IEEE 802.11 embodiments, the radio architecture 900A, 900B may be configured for communication over various channel bandwidths including bandwidths having center frequencies of about 900 MHZ, 2.4 GHZ, 5 GHZ, and bandwidths of about 2 MHz, 4 MHz, 5 MHz, 5.5 MHz, 6 MHZ, 8 MHz, 10 MHz, 20 MHz, 40 MHz, 80 MHz (with contiguous bandwidths) or 80+80 MHZ (160 MHZ) (with non-contiguous bandwidths). In some embodiments, a 920 MHz channel bandwidth may be used. The scope of the embodiments is not limited with respect to the above center frequencies however.

FIG. 10 is a functional block diagram of WLAN FEM circuitry 904a in accordance with some embodiments of the disclosure. Although the example of FIG. 10 is described in conjunction with the WLAN FEM circuitry 904a, the example of FIG. 10 may be described in conjunction with the example BT FEM circuitry 904b (FIG. 9), although other circuitry configurations may also be suitable.

In some embodiments, the FEM circuitry 904a may include a TX/RX switch 1002 to switch between transmit mode and receive mode operation. The FEM circuitry 904a may include a receive signal path and a transmit signal path. The receive signal path of the FEM circuitry 904a may include a low-noise amplifier (LNA) 1006 to amplify received RF signals 1003 and provide the amplified received RF signals 1007 as an output (e.g., to the radio IC circuitry 906a-b (FIG. 9)). The transmit signal path of the circuitry 904a may include a power amplifier (PA) to amplify input RF signals 1009 (e.g., provided by the radio IC circuitry 906a-b), and one or more filters 1012, such as band-pass filters (BPFs), low-pass filters (LPFs) or other types of filters, to generate RF signals 1015 for subsequent transmission (e.g., by one or more of the antennas 901 (FIG. 9)) via an example duplexer 1014.

In some dual-mode embodiments for Wi-Fi communication, the FEM circuitry 904a may be configured to operate in either the 2.4 GHz frequency spectrum or the 5 GHz frequency spectrum. In these embodiments, the receive signal path of the FEM circuitry 904a may include a receive signal path duplexer 1004 to separate the signals from each spectrum as well as provide a separate LNA 1006 for each spectrum as shown. In these embodiments, the transmit signal path of the FEM circuitry 904a may also include a power amplifier 1010 and a filter 1012, such as a BPF, an LPF or another type of filter for each frequency spectrum and a transmit signal path duplexer 1004 to provide the signals of one of the different spectrums onto a single transmit path for subsequent transmission by the one or more of the antennas 901 (FIG. 9). In some embodiments, BT communications may utilize the 2.4 GHz signal paths and may utilize the same FEM circuitry 904a as the one used for WLAN communications.

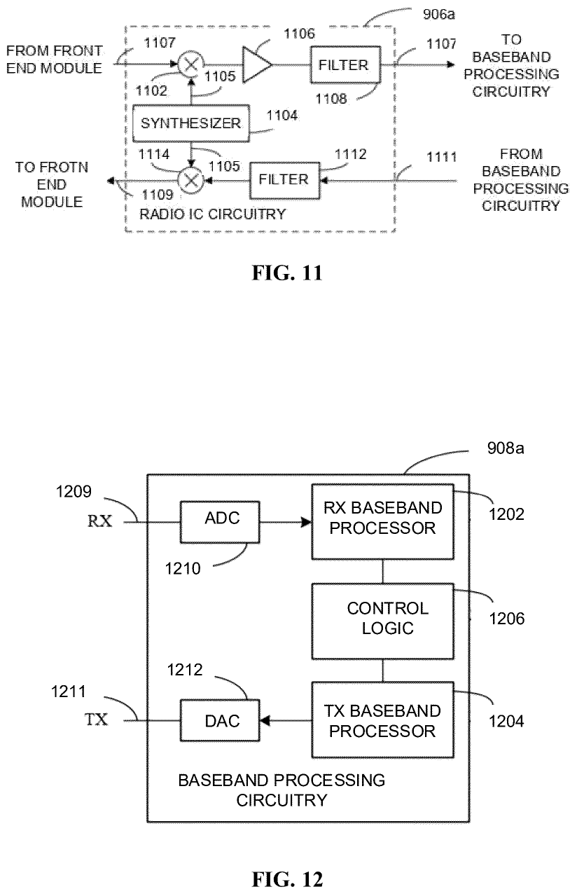

FIG. 11 is a functional block diagram of radio IC circuitry 906a in accordance with some embodiments of the disclosure. The radio IC circuitry 906a is one example of circuitry that may be suitable for use as the WLAN or BT radio IC circuitry 906a/906b (FIG. 9), although other circuitry configurations may also be suitable. Alternatively, the example of FIG. 11 may be described in conjunction with the example BT radio IC circuitry 906b.

In some embodiments, the radio IC circuitry 906a may include a receive signal path and a transmit signal path. The receive signal path of the radio IC circuitry 906a may include at least mixer circuitry 1102, such as, for example, down-conversion mixer circuitry, amplifier circuitry 1106 and filter circuitry 1108. The transmit signal path of the radio IC circuitry 906a may include at least filter circuitry 1112 and mixer circuitry 1114, such as, for example, up-conversion mixer circuitry. Radio IC circuitry 906a may also include synthesizer circuitry 1104 for synthesizing a frequency 1105 for use by the mixer circuitry 1102 and the mixer circuitry 1114. The mixer circuitry 1102 and/or 1114 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 11 illustrates only a simplified version of a radio IC circuitry, and may include, although not shown, embodiments where each of the depicted circuitries may include more than one component. For instance, mixer circuitry 1114 may each include one or more mixers, and filter circuitries 1108 and/or 1112 may cach include one or more filters, such as one or more BPFs and/or LPFs according to application needs. For example, when mixer circuitries are of the direct-conversion type, they may each include two or more mixers.

In some embodiments, mixer circuitry 1102 may be configured to down-convert RF signals 1007 received from the FEM circuitry 904a-b (FIG. 9) based on the synthesized frequency 1105 provided by synthesizer circuitry 1104. The amplifier circuitry 1106 may be configured to amplify the down-converted signals and the filter circuitry 1108 may include an LPF configured to remove unwanted signals from the down-converted signals to generate output baseband signals 1107. Output baseband signals 1107 may be provided to the baseband processing circuitry 908a-b (FIG. 9) for further processing. In some embodiments, the output baseband signals 1107 may be zero-frequency baseband signals, although this is not a requirement. In some embodiments, mixer circuitry 1102 may comprise passive mixers, although the scope of the embodiments is not limited in this respect.

In some embodiments, the mixer circuitry 1114 may be configured to up-convert input baseband signals 1111 based on the synthesized frequency 1105 provided by the synthesizer circuitry 1104 to generate RF output signals 1009 for the FEM circuitry 904a-b. The baseband signals 1111 may be provided by the baseband processing circuitry 908a-b and may be filtered by filter circuitry 1112. The filter circuitry 1112 may include an LPF or a BPF, although the scope of the embodiments is not limited in this respect.

In some embodiments, the mixer circuitry 1102 and the mixer circuitry 1114 may each include two or more mixers and may be arranged for quadrature down-conversion and/or up-conversion respectively with the help of synthesizer 1104. In some embodiments, the mixer circuitry 1102 and the mixer circuitry 1114 may each include two or more mixers each configured for image rejection (e.g., Hartley image rejection). In some embodiments, the mixer circuitry 1102 and the mixer circuitry 1114 may be arranged for direct down-conversion and/or direct up-conversion, respectively. In some embodiments, the mixer circuitry 1102 and the mixer circuitry 1114 may be configured for super-heterodyne operation, although this is not a requirement.

Mixer circuitry 1102 may comprise, according to one embodiment: quadrature passive mixers (e.g., for the in-phase (I) and quadrature phase (Q) paths). In such an embodiment, RF input signal 1007 from FIG. 11 may be down-converted to provide I and Q baseband output signals to be transmitted to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1105 of synthesizer 1104 (FIG. 11). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1007 (FIG. 10) may comprise a balanced signal, although the scope of the embodiments is not limited in this respect. The I and Q baseband output signals may be provided to low-noise amplifier, such as amplifier circuitry 1106 (FIG. 11) or to filter circuitry 1108 (FIG. 11).

In some embodiments, the output baseband signals 1107 and the input baseband signals 1111 may be analog baseband signals, although the scope of the embodiments is not limited in this respect. In some alternate embodiments, the output baseband signals 1107 and the input baseband signals 1111 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1104 may be a fractional-N synthesizer or a fractional N/N+1 synthesizer, although the scope of the embodiments is not limited in this respect as other types of frequency synthesizers may be suitable. For example, synthesizer circuitry 1104 may be a delta-sigma synthesizer, a frequency multiplier, or a synthesizer comprising a phase-locked loop with a frequency divider. According to some embodiments, the synthesizer circuitry 1104 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 1104 may be provided by a voltage controlled oscillator (VCO), although that is not a requirement. A divider control input may further be provided by either the baseband processing circuitry 908a-b (FIG. 9) depending on the desired output frequency 1105. In some embodiments, a divider control input (e.g., N) may be determined from a look-up table (e.g., within a Wi-Fi card) based on a channel number and a channel center frequency as determined or indicated by the example application processor 910. The application processor 910 may include, or otherwise be connected to, one of the example security signal converter 101 or the example received signal converter 103 (e.g., depending on which device the example radio architecture is implemented in).

In some embodiments, synthesizer circuitry 1104 may be configured to generate a carrier frequency as the output frequency 1105, while in other embodiments, the output frequency 1105 may be a fraction of the carrier frequency (e.g., one-half the carrier frequency, one-third the carrier frequency). In some embodiments, the output frequency 1105 may be a LO frequency (fLO).

FIG. 12 is a functional block diagram of baseband processing circuitry 908a in accordance with some embodiments of the disclosure. The baseband processing circuitry 908a is one example of circuitry that may be suitable for use as the baseband processing circuitry 908a (FIG. 9), although other circuitry configurations may also be suitable. Alternatively, the example of FIG. 11 may be used to implement the example BT baseband processing circuitry 908b of FIG. 9.

The baseband processing circuitry 908a may include a receive baseband processor (RX BBP) 1202 for processing receive baseband signals 1109 provided by the radio IC circuitry 906a-b (FIG. 9) and a transmit baseband processor (TX BBP) 1204 for generating transmit baseband signals 1111 for the radio IC circuitry 906a-b. The baseband processing circuitry 908a may also include control logic 1206 for coordinating the operations of the baseband processing circuitry 908a.

In some embodiments (e.g., when analog baseband signals are exchanged between the baseband processing circuitry 908a-b and the radio IC circuitry 906a-b), the baseband processing circuitry 908a may include ADC 1210 to convert analog baseband signals 1209 received from the radio IC circuitry 906a-b to digital baseband signals for processing by the RX BBP 1202. In these embodiments, the baseband processing circuitry 908a may also include DAC 1212 to convert digital baseband signals from the TX BBP 1204 to analog baseband signals 1211.

In some embodiments that communicate OFDM signals or OFDMA signals, such as through baseband processor 908a, the transmit baseband processor 1204 may be configured to generate OFDM or OFDMA signals as appropriate for transmission by performing an inverse fast Fourier transform (IFFT). The receive baseband processor 1202 may be configured to process received OFDM signals or OFDMA signals by performing an FFT. In some embodiments, the receive baseband processor 1202 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 9, in some embodiments, the antennas 901 (FIG. 9) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 901 may each include a set of phased-array antennas, although embodiments are not so limited.

Although the radio architecture 900A, 900B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following paragraphs describe examples of various embodiments.

Example 1 includes an apparatus used in a non-Access Point (non-AP) Station (STA), wherein the apparatus comprises processor circuitry configured to cause the non-AP STA to: transmit a frame, which is used to solicit privacy beacon frames; and receive a privacy beacon frame from an AP.

Example 2 includes the apparatus of Example 1, wherein the frame is an Enhanced Data Privacy (EDP) action frame or a probe request frame.

Example 3 includes the apparatus of any one of Examples 1-2, wherein the frame comprises an identifier element containing an identifier field, which is computed based on an Extended Service Set (ESS) identity key preconfigured for the non-AP STA, and the privacy beacon frame is an encrypted privacy beacon frame.

Example 4 includes the apparatus of any one of Examples 1-3, wherein the frame does not comprise the identifier element, and the privacy beacon frame is an unencrypted privacy beacon frame.

Example 5 includes the apparatus of any one of Examples 1-4, wherein the privacy beacon frame comprises an over-the-air identifier, which is computed based on an ESS identity key preconfigured for the AP.

Example 6 includes the apparatus of any one of Examples 1-5, wherein the privacy beacon frame comprises an Address 1 field, an Address 2 field, and a timestamp field in a Media Access Control (MAC) header.

Example 7 includes the apparatus of any one of Examples 1-6, wherein the privacy beacon frame comprises a Robust Security Network Element (RSNE) and a Robust Security Network eXtension Element (RSNXE) in its body part.

Example 8 includes the apparatus of any one of Examples 1-7, wherein the privacy beacon frame comprises a basic multi-link element in its body part, and the basic multi-link element comprises only a Multi-Link Device (MLD) MAC address.

Example 9 includes the apparatus of any one of Examples 1-8, wherein Additional Authentication Data (AAD) of the privacy beacon frame is constructed based on a MAC header of the privacy beacon frame with a timestamp field of the MAC header masked out.

Example 10 includes an apparatus used in an Access Point (AP), wherein the apparatus comprises processor circuitry configured to cause the AP to: receive a frame, which is used to solicit privacy beacon frames, from a non-AP STA; and transmit a privacy beacon frame to the non-AP STA in response to the frame.

Example 11 includes the apparatus of Example 10, wherein the processor circuitry is further configured to cause the AP to: check whether the frame comprises an identifier element; and when the frame does not comprise the identifier element, transmit an unencrypted privacy beacon frame as the privacy beacon frame to the non-AP STA.

Example 12 includes the apparatus of any one of Examples 10-11, wherein the processor circuitry is further configured to cause the AP to, when the frame comprises the identifier element: compute an over-the-air identifier based on an Extended Service Set (ESS) identity key preconfigured for the AP; check whether the over-the-air identifier matches with an identifier field, which is computed based on an ESS identity key preconfigured for the non-AP STA, in the identifier element; and when the over-the-air identifier matches with the identifier field, transmit an encrypted privacy beacon frame as the privacy beacon frame to the non-AP STA.

Example 13 includes the apparatus of any one of Examples 10-12, wherein the privacy beacon frame comprises an over-the-air identifier, which is computed based on an ESS identity key preconfigured for the AP.

Example 14 includes the apparatus of any one of Examples 10-13, wherein the privacy beacon frame comprises an Address 1 field, an Address 2 field, and a timestamp field in a Media Access Control (MAC) header.

Example 15 includes the apparatus of any one of Examples 10-14, wherein the privacy beacon frame comprises a Robust Security Network Element (RSNE) and a Robust Security Network eXtension Element (RSNXE) in its body part.

Example 16 includes the apparatus of any one of Examples 10-15, wherein the privacy beacon frame comprises a basic multi-link element in its body part.

Example 17 includes the apparatus of any one of Examples 10-16, wherein the basic multi-link element comprises only a Multi-Link Device (MLD) MAC address.

Example 18 includes the apparatus of any one of Examples 10-17, wherein Additional Authentication Data (AAD) of the privacy beacon frame is constructed based on a MAC header of the privacy beacon frame with a timestamp field of the MAC header masked out.

Example 19 includes a non-Access Point (non-AP) Station (STA), comprising the apparatus of any one of Examples 1-9.

Example 20 includes an Access Point (AP), comprising the apparatus of any one of Examples 10-18.

Example 21 includes a method used in a non-Access Point (non-AP) Station (STA), wherein the method comprises: transmitting a frame, which is used to solicit privacy beacon frames; and receiving a privacy beacon frame from an AP.

Example 22 includes the method of Example 21, wherein the frame is an Enhanced Data Privacy (EDP) action frame or a probe request frame.

Example 23 includes the method of any one of Examples 21-22, wherein the frame comprises an identifier element containing an identifier field, which is computed based on an Extended Service Set (ESS) identity key preconfigured for the non-AP STA, and the privacy beacon frame is an encrypted privacy beacon frame.

Example 24 includes the method of any one of Examples 21-23, wherein the frame does not comprise the identifier element, and the privacy beacon frame is an unencrypted privacy beacon frame.

Example 25 includes the method of any one of Examples 21-24, wherein the privacy beacon frame comprises an over-the-air identifier, which is computed based on an ESS identity key preconfigured for the AP.

Example 26 includes the method of any one of Examples 21-25, wherein the privacy beacon frame comprises an Address 1 field, an Address 2 field, and a timestamp field in a Media Access Control (MAC) header.

Example 27 includes the method of any one of Examples 21-26, wherein the privacy beacon frame comprises a Robust Security Network Element (RSNE) and a Robust Security Network extension Element (RSNXE) in its body part.

Example 28 includes the method of any one of Examples 21-27, wherein the privacy beacon frame comprises a basic multi-link element in its body part, and the basic multi-link element comprises only a Multi-Link Device (MLD) MAC address.

Example 29 includes the method of any one of Examples 21-28, wherein Additional Authentication Data (AAD) of the privacy beacon frame is constructed based on a MAC header of the privacy beacon frame with a timestamp field of the MAC header masked out.

Example 30 includes a method used in an Access Point (AP), wherein the method comprises: receiving a frame, which is used to solicit privacy beacon frames, from a non-AP STA; and transmitting a privacy beacon frame to the non-AP STA in response to the frame.

Example 31 includes the method 30, wherein the method further comprises: checking whether the frame comprises an identifier element; and when the frame does not comprise the identifier element, transmitting an unencrypted privacy beacon frame as the privacy beacon frame to the non-AP STA.

Example 32 includes the method of any one of Examples 30-31, wherein the method further comprises, when the frame comprises the identifier element: computing an over-the-air identifier based on an Extended Service Set (ESS) identity key preconfigured for the AP; checking whether the over-the-air identifier matches with an identifier field, which is computed based on an ESS identity key preconfigured for the non-AP STA, in the identifier element; and when the over-the-air identifier matches with the identifier field, transmitting an encrypted privacy beacon frame as the privacy beacon frame to the non-AP STA.

Example 33 includes the method of any one of Examples 30-32, wherein the privacy beacon frame comprises an over-the-air identifier, which is computed based on an ESS identity key preconfigured for the AP.

Example 34 includes the method of any one of Examples 30-33, wherein the privacy beacon frame comprises an Address 1 field, an Address 2 field, and a timestamp field in a Media Access Control (MAC) header.

Example 35 includes the method of any one of Examples 30-34, wherein the privacy beacon frame comprises a Robust Security Network Element (RSNE) and a Robust Security Network extension Element (RSNXE) in its body part.

Example 36 includes the method of any one of Examples 30-35, wherein the privacy beacon frame comprises a basic multi-link element in its body part.

Example 37 includes the method of any one of Examples 30-36, wherein the basic multi-link element comprises only a Multi-Link Device (MLD) MAC address.

Example 38 includes the method of any one of Examples 30-37, wherein Additional Authentication Data (AAD) of the privacy beacon frame is constructed based on a MAC header of the privacy beacon frame with a timestamp field of the MAC header masked out.

Example 39 includes a non-transitory computer readable storage medium storing computer executable instructions thereon, wherein the computer executable instructions, when executed by one or more processors of a non-Access Point (non-AP), cause the non-AP to implement the method of any one of Examples 21-29.

Example 40 includes a non-transitory computer readable storage medium storing computer executable instructions thereon, wherein the computer executable instructions, when executed by one or more processors of an Access Point (AP), cause the AP to implement the method of any one of Examples 30-38.

Example 41 includes an apparatus used in a Multi-Link Device (MLD), wherein the apparatus comprises processor circuitry configured to cause the MLD to generate and transmit a frame carrying an element containing epoch setting, which includes a field with a Time Synchronization Function (TSF) value to determine next epoch start time, wherein: a Multi-Link Operation (MLO) Link Information element is not included in the frame, the field with the TSF value is determined based on the TSF value of an AP corresponding to a link that is used to transmit the frame; or the MLO link information element is included in the frame, the field with the TSF value is determined based on the TSF value of the AP corresponding to the link indicated in the MLO Link Information element.

Example 42 includes the apparatus of Example 41, wherein the processor circuitry is further configured to cause the MLD to, for another link different from the link that is used to transmit the frame or the link indicated in the MLO Link Information element: modify the next epoch start time of the another link by a TSF offset of an AP corresponding to the another link based on the TSF value of the AP corresponding to the link that is used to transmit the frame or the link indicated in the MLO Link Information element.

Example 43 includes the apparatus of any one of Examples 41-42, wherein the processor circuitry is further configured to cause the MLD to, for an epoch sequence indicated by the element containing epoch setting: determine a delta value for determining start time of the next epoch in the epoch sequence by using a hash algorithm based on a Privacy Group Temporal Key (PGTK) and an iteration number corresponding to the next epoch, wherein the PGTK is a cryptographic key assigned by an AP MLD that is used to manage the epoch sequence and distributed to non-AP MLDs associated with the AP MLD.

Example 44 includes the apparatus of any one of Examples 41-43, wherein the processor circuitry is further configured to cause the MLD to, when start time of the next epoch in an epoch sequence indicated by the element containing epoch setting is triggered in a link: update anonymization parameters of all links and start to use the updated anonymization parameters to anonymize selected Over-The-Air (OTA) fields of all new individual frames transmitted during the next epoch in all the links.

Example 45 includes the apparatus of any one of Examples 41-44, wherein the processor circuitry is further configured to cause the MLD to, when an event to update parameters for transmission is triggered in a link for the next epoch in an epoch sequence indicated by the element containing epoch setting and the event is triggered inside a Transmission Opportunity (TXOP), defer the event to start at the end of the TXOP.

Example 46 includes the apparatus of any one of Examples 41-45, wherein the processor circuitry is further configured to cause the MLD to, when beginning to accept received individually addressed frames that use new anonymization parameters for the next epoch in an epoch sequence indicated by the element containing epoch setting in a link and an event of a dot11EpochStartTimeMargin before the start of the next epoch is triggered: begin to accept received individually addressed frames that use the new anonymization parameters for the next epoch in all other links from start time of the next epoch.

Example 47 includes the apparatus of any one of Examples 41-46, wherein the element containing epoch setting is an Enhanced Data Privacy (EDP) element, an Enhanced Group Privacy Availability (EGPA) element, or an EPD Epoch Setting element.

Example 48 includes the apparatus of any one of Examples 41-47, wherein the apparatus comprises processor circuitry configured to cause the MLD to transmit another frame including a PGTK Switch Time field to indicate time that the MLD transmitting the another frame switches to use a PGTK, wherein: the MLO Link Information element is not included in the another frame, the PGTK Switch Time field is determined based on the TSF value of the AP corresponding to a link that is used to transmit the another frame; or the MLO link information element is included in the another frame, the PGTK Switch Time field is determined based on the TSF value of the AP corresponding to the link indicated in the MLO Link Information element.

Example 49 includes the apparatus of any one of Examples 41-48, wherein a Wrapped Key field, in which the PGTK is comprised, and the PGTK Switch Time field are both comprised in a PGTK subelement.

Example 50 includes the apparatus of any one of Examples 41-49, wherein a PGTK field, in which the PGTK is comprised, and the PGTK Switch Time field are both comprised in a PGTK key data encapsulation (KDE).

Example 51 includes the apparatus of any one of Examples 41-50, wherein the PGTK KDE is comprised in message 3 of 4-way handshake, in message 1 of group key handshake, or in key delivery element in an association response frame.

Example 52 includes a Multi-Link Device (MLD), wherein the MLD comprises the apparatus of any one of Examples 41-51.

Example 53 includes a method used in a Multi-Link Device (MLD), wherein the method comprises generating and transmitting a frame carrying an element containing epoch setting, which includes a field with a Time Synchronization Function (TSF) value to determine next epoch start time, wherein: a Multi-Link Operation (MLO) Link Information element is not included in the frame, the field with the TSF value is determined based on the TSF value of an AP corresponding to a link that is used to transmit the frame; or the MLO link information element is included in the frame, the field with the TSF value is determined based on the TSF value of the AP corresponding to the link indicated in the MLO Link Information element.

Example 54 includes the method of Example 53, wherein the method further comprises, for another link different from the link that is used to transmit the frame or the link indicated in the MLO Link Information element: modifying the next epoch start time of the another link by a TSF offset of an AP corresponding to the another link based on the TSF value of the AP corresponding to the link that is used to transmit the frame or the link indicated in the MLO Link Information element.

Example 55 includes the method of any one of Examples 53-54, wherein the method further comprises, for an epoch sequence indicated by the element containing epoch setting: determining a delta value for determining start time of the next epoch in the epoch sequence by using a hash algorithm based on a Privacy Group Temporal Key (PGTK) and an iteration number corresponding to the next epoch, wherein the PGTK is a cryptographic key assigned by an AP MLD that is used to manage the epoch sequence and distributed to non-AP MLDs associated with the AP MLD.

Example 56 includes the method of any one of Example 53-55, wherein the method further comprises, when start time of the next epoch in an epoch sequence indicated by the element containing epoch setting is triggered in a link: updating anonymization parameters of all links and starting to use the updated anonymization parameters to anonymize selected Over-The-Air (OTA) fields of all new individual frames transmitted during the next epoch in all the links.

Example 57 includes the method of any one of Examples 53-56, wherein the method further comprises, when an event to update parameters for transmission is triggered in a link for the next epoch in an epoch sequence indicated by the element containing epoch setting and the event is triggered inside a Transmission Opportunity (TXOP): deferring the event to start at the end of the TXOP.

Example 58 includes the method of any one of Examples 53-57, wherein the method further comprises, when beginning to accept received individually addressed frames that use new anonymization parameters for the next epoch in an epoch sequence indicated by the element containing epoch setting in a link and an event of a dot11EpochStartTimeMargin before the start of the next epoch is triggered: beginning to accept received individually addressed frames that use the new anonymization parameters for the next epoch in all other links from start time of the next epoch.

Example 59 includes the method of any one of Examples 53-58, wherein the element containing epoch setting is an Enhanced Data Privacy (EDP) element, an Enhanced Group Privacy Availability (EGPA) element, or an EPD Epoch Setting element.

Example 60 includes the method of any one of Examples 53-59, wherein the method further comprises transmitting another frame including a PGTK Switch Time field to indicate time that the MLD transmitting the another frame switches to use a PGTK, wherein: the MLO Link Information element is not included in the another frame, the PGTK Switch Time field is determined based on the TSF value of the AP corresponding to a link that is used to transmit the another frame; or the MLO link information element is included in the another frame, the PGTK Switch Time field is determined based on the TSF value of the AP corresponding to the link indicated in the MLO Link Information element.

Example 61 includes the method of any one of Examples 53-60, wherein a Wrapped Key field, in which the PGTK is comprised, and the PGTK Switch Time field are both comprised in a PGTK subelement.

Example 62 includes the method of any one of Examples 53-61, wherein a PGTK field, in which the PGTK is comprised, and the PGTK Switch Time field are both comprised in a PGTK key data encapsulation (KDE).

Example 63 includes the method of any one of Examples 43-62, wherein the PGTK KDE is comprised in message 3 of 4-way handshake, in message 1 of group key handshake, or in key delivery element in an association response frame.

Example 64 includes a non-transitory computer readable storage medium storing computer executable instructions thereon, wherein the computer executable instructions, when executed by one or more processors of a Multi-Link Device (MLD), cause the MLD to implement the method of any one of Examples 53-63.

Although certain embodiments have been illustrated and described herein for purposes of description, a wide variety of alternate and/or equivalent embodiments or implementations calculated to achieve the same purposes may be substituted for the embodiments shown and described without departing from the scope of the disclosure. This application is intended to cover any adaptations or variations of the embodiments discussed herein. Therefore, it is manifestly intended that embodiments described herein be limited only by the appended claims and the equivalents thereof.

What is claimed is:

1. An apparatus used in a Multi-Link Device (MLD), wherein the apparatus comprises processor circuitry configured to cause the MLD to generate and transmit a frame carrying an element containing epoch setting, which includes a field with a Time Synchronization Function (TSF) value to determine next epoch start time, wherein:
a Multi-Link Operation (MLO) Link Information element is not included in the frame, the field with the TSF value is determined based on the TSF value of an AP corresponding to a link that is used to transmit the frame; or
the MLO link information element is included in the frame, the field with the TSF value is determined based on the TSF value of the AP corresponding to the link indicated in the MLO Link Information element.

2. The apparatus of claim 1, wherein the processor circuitry is further configured to cause the MLD to, for another link different from the link that is used to transmit the frame or the link indicated in the MLO Link Information element:
modify the next epoch start time of the another link by a TSF offset of an AP corresponding to the another link based on the TSF value of the AP corresponding to the link that is used to transmit the frame or the link indicated in the MLO Link Information element.

3. The apparatus of claim 1, wherein the processor circuitry is further configured to cause the MLD to, for an epoch sequence indicated by the element containing epoch setting:
determine a delta value for determining start time of the next epoch in the epoch sequence by using a hash algorithm based on a Privacy Group Temporal Key (PGTK) and an iteration number corresponding to the next epoch, wherein the PGTK is a cryptographic key assigned by an AP MLD that is used to manage the epoch sequence and distributed to non-AP MLDs associated with the AP MLD.

4. The apparatus of claim 1, wherein the processor circuitry is further configured to cause the MLD to, when start time of the next epoch in an epoch sequence indicated by the element containing epoch setting is triggered in a link:
update anonymization parameters of all links and start to use the updated anonymization parameters to anonymize selected Over-The-Air (OTA) fields of all new individual frames transmitted during the next epoch in all the links.

5. The apparatus of claim 1, wherein the processor circuitry is further configured to cause the MLD to, when an event to update parameters for transmission is triggered in a link for the next epoch in an epoch sequence indicated by the element containing epoch setting and the event is triggered inside a Transmission Opportunity (TXOP), defer the event to start at the end of the TXOP.

6. The apparatus of claim 1, wherein the processor circuitry is further configured to cause the MLD to, when beginning to accept received individually addressed frames that use new anonymization parameters for the next epoch in an epoch sequence indicated by the element containing epoch setting in a link and an event of a dot11EpochStartTimeMargin before the start of the next epoch is triggered:
begin to accept received individually addressed frames that use the new anonymization parameters for the next epoch in all other links from start time of the next epoch.

7. The apparatus of claim 1, wherein the element containing epoch setting is an Enhanced Data Privacy (EDP) element, an Enhanced Group Privacy Availability (EGPA) element, or an EPD Epoch Setting element.

8. The apparatus of claim 1, wherein the apparatus comprises processor circuitry configured to cause the MLD to transmit another frame including a PGTK Switch Time field to indicate time that the MLD transmitting the another frame switches to use a PGTK, wherein:
the MLO Link Information element is not included in the another frame, the PGTK Switch Time field is determined based on the TSF value of the AP corresponding to a link that is used to transmit the another frame; or
the MLO link information element is included in the another frame, the PGTK Switch Time field is determined based on the TSF value of the AP corresponding to the link indicated in the MLO Link Information element.

9. The apparatus of claim 8, wherein a Wrapped Key field, in which the PGTK is comprised, and the PGTK Switch Time field are both comprised in a PGTK subelement.

10. The apparatus of claim 8, wherein a PGTK field, in which the PGTK is comprised, and the PGTK Switch Time field are both comprised in a PGTK key data encapsulation (KDE).

11. The apparatus of claim 10, wherein the PGTK KDE is comprised in message 3 of 4-way handshake, in message 1 of group key handshake, or in key delivery element in an association response frame.

12. A Multi-Link Device (MLD), comprising processor circuitry configured to cause the MLD to generate and transmit a frame carrying an element containing epoch setting, which includes a field with a Time Synchronization Function (TSF) value to determine next epoch start time, wherein:
a Multi-Link Operation (MLO) Link Information element is not included in the frame, and the field with the TSF value is determined based on the TSF value of an AP corresponding to a link that is used to transmit the frame;
the MLO link information element is included in the frame, and the field with the TSF value is determined based on the TSF value of the AP corresponding to the link indicated in the MLO Link Information element.

13. The MLD of claim 12, wherein the processor circuitry is further configured to cause the MLD to, for another link different from the link that is used to transmit the frame or the link indicated in the MLO Link Information element:
modify the next epoch start time of the another link by a TSF offset of an AP corresponding to the another link based on the TSF value of the AP corresponding to the link that is used to transmit the frame or the link indicated in the MLO Link Information element.

14. The MLD of claim 12, wherein the processor circuitry is further configured to cause the MLD to, for an epoch sequence indicated by the element containing epoch setting:
determine a delta value for determining start time of the next epoch in the epoch sequence by using a hash algorithm based on a Privacy Group Temporal Key (PGTK) and an iteration number corresponding to the next epoch, wherein the PGTK is a cryptographic key assigned by an AP MLD that is used to manage the epoch sequence and distributed to non-AP MLDs associated with the AP MLD.

15. The MLD of claim 12, wherein the processor circuitry is further configured to cause the MLD to, when start time of the next epoch in an epoch sequence indicated by the element containing epoch setting is triggered in a link:
update anonymization parameters of all links and start to use the updated anonymization parameters to anonymize selected Over-The-Air (OTA) fields of all new individual frames transmitted during the next epoch in all the links.

16. The MLD of claim 12, wherein the processor circuitry is further configured to cause the MLD to, when an event to update parameters for transmission is triggered in a link for the next epoch in an epoch sequence indicated by the element containing epoch setting and the event is triggered inside a Transmission Opportunity (TXOP), defer the event to start at the end of the TXOP.

17. A non-transitory computer readable storage medium storing computer executable instructions thereon, wherein the computer executable instructions, when executed by one or more processors of a Multi-Link Device (MLD), cause the MLD to generate and transmit a frame carrying an element containing epoch setting, which includes a field with a Time Synchronization Function (TSF) value to determine next epoch start time, wherein:
a Multi-Link Operation (MLO) Link Information element is not included in the frame, and the field with the TSF value is determined based on the TSF value of an AP corresponding to a link that is used to transmit the frame;
the MLO link information element is included in the frame, and the field with the TSF value is determined based on the TSF value of the AP corresponding to the link indicated in the MLO Link Information element.

18. The non-transitory computer readable storage medium of claim 17, wherein the computer executable instructions, when executed by the one or more processors, further cause the MLD to, for another link different from the link that is used to transmit the frame or the link indicated in the MLO Link Information element:
modify next epoch start time of the another link by a TSF offset of an AP corresponding to the another link based on the TSF value of the AP corresponding to the link that is used to transmit the frame or the link indicated in the MLO Link Information element.

19. The non-transitory computer readable storage medium of claim 17, wherein the computer executable instructions, when executed by the one or more processors, further cause the MLD to, for an epoch sequence indicated by the element containing epoch setting:
determine a delta value for determining start time of the next epoch in the epoch sequence by using a hash algorithm based on a Privacy Group Temporal Key (PGTK) and an iteration number corresponding to the next epoch, wherein the PGTK is a cryptographic key assigned by an AP MLD that is used to manage the epoch sequence and distributed to non-AP MLDs associated with the AP MLD.

20. The non-transitory computer readable storage medium of claim 17, wherein the computer executable instructions, when executed by the one or more processors, further cause the MLD to, when start time of the next epoch in an epoch sequence indicated by the element containing epoch setting is triggered in a link:
update anonymization parameters of all links and start to use the updated anonymization parameters to anonymize selected Over-The-Air (OTA) fields of all new individual frames transmitted during the next epoch in all the links.
